(19) United States
(12) Patent Application Publication
(10) Pub. No.: US 2014/0351678 A1
(43) Pub. Date: Nov. 27, 2014

(54) Method and System for Associating Data with Figures

(71) Applicant: European Molecular Biology Organisation, Heidelberg (DE)

(72) Inventor: Thomas Lemberger, Heidelberg (DE)

(21) Appl. No.: 13/899,891

(22) Filed: May 22, 2013

(51) Int. Cl. G06F 17/21

(52) U.S. Cl. CPC G06F 17/212
USPC 715/202

(57) ABSTRACT

A system and method for associating data with figures is disclosed. The system comprises a figure storage database and one or more data files storing a plurality of data items associated with the plurality of figures. The system provides a curation tool that enables the association of the plurality of data items with legends on the figures and a computer-readable representation of the figure and enables searches of underlying data.

### CROSS-REFERENCE TO OTHER APPLICATIONS

None

### FIELD OF THE INVENTION

The invention relates to a system and method for associating data with figures, for example in a document, such as but not limited to a scientific paper.

### BACKGROUND OF THE INVENTION

Much research data are published in scientific papers as figures, which do not allow a re-analysis of the underlying “raw” research data (i.e. “source data”) and are inaccessible to systematic data mining or search.

The effective exchange of research data forms a cornerstone of the scientific method and leads to advancement of knowledge and science. An analysis of the research data supporting scientific claims and the combination of datasets including this research data in order to generate new discoveries are an integral part of the modern scientific process. The publication of research findings in scientific papers in peer-reviewed scientific journals is the dominant channel for exchange and archiving of scientific knowledge.

Public data repositories exist for some types of large-scale biological data (for example, in the fields of genomics or proteomics), for astronomical data, for data relating to the properties of materials, etc. However, most of the research data published in the sciences are not based on high-throughput technologies and are not deposited in structured databases. In published scientific papers, these items research data are only available in the form of narrative textual descriptions, figures or tables.

In the biomedical and other scientific literature, figures in the scientific papers represent the principal means to communicate the evidence based on source data that formally supports scientific claims. The figures are published as images, which are currently not amenable to data mining and search. The figures are purely visual representation of summarized data derived from the original research data and serve to illustrate the narrative of the scientific paper. In this format, re-analysis or integration of the research data with other datasets containing additional data terms is impossible. The central components of the scientific papers, i.e. the research data, remain essentially inaccessible to in-depth analysis and re-use.

An additional hurdle to efficient access to the research data is caused by the rapid increase of the volume of the scientific literature. Close to one million scientific papers are published every year in the life sciences alone, which is twice as much as 10 years ago. Such publications include publications in traditional paid-for journals, open-access journals, rapid-access journals, as well as (often un-reviewed) pre-print databases. Fundamental tasks, such as verifying whether a particular experiment has already been published or searching the scientific literature to retrieve specific facts is increasingly challenging.

These issues have negative consequences for scientific research and significantly reduce the value of the research data, as well as increasing the costs of research.

Government and other funding agencies have identified long-term preservation of the research data as a priority for the development of an efficient research infrastructure. Resources are being developed to improve scientific data management. Examples of such resources include, but are not limited to, data repositories (such as ArrayEpresss http://www.ebi.ac.uk/arrayexpress/), curated knowledge bases (such as UniProtKB/Swiss-Prot, uniprot.org) and ontology collections (such as NCBO BioPortal, bioportal.bioontology.org). These resources and the related tools are, however, not currently integrated with the publication process of scientific papers. Bridging the research data published in the scientific literature and the data items stored in datasets in such resources will improve the rigor and depth of scientific reporting in published papers and it will add quality assurance to the research data by cross-linking datasets to the peer-reviewed papers.

PubMed, the major search engine for the biomedical literature, was launched in 1996, two years before Google. Currently PubMed (as well as the Google search engine) only provide links to papers at the level of entire papers. Similarly biological knowledge bases such as UniProtKB/Swiss-Prot or Reactome (reactome.org) provide also links to the published literature only at the level of entire scientific papers.

At the same time, the scientific literature underwent a transition to online publishing, which was followed by the creation of the first open access journals. These developments have fundamentally changed the way in which researchers access scientific information, including research data. A series of recent reports (‘Riding the Wave’, 2010, European Commission; ‘Science as an open enterprise’ 2012, The Royal Society; the Finch report on ‘Accessibility, sustainability, excellence: how to expand access to research publications’, 2012, Research Information Network) have highlighted the profound consequences of this transition and emphasized the scientific, economical and social benefits of providing easy access to the research data and the tremendous potential of ‘intelligently open data’ (‘Science as an open enterprise’, 2012) to generate new discoveries and accelerate scientific progress.

There is therefore a need for tools to enable scientific journals to publish figures as structured online digital objects that overcome the limitation of the current purely visual and stylized representation of the research data in the papers.

### SUMMARY OF THE INVENTION

A method and system for making available “source data” underlying published figures in a paper is disclosed. The term “source data” is used to indicate the basic raw data obtained from experiments, observations, etc., that is used to generate the graphical elements in the published figures. Such source data includes, but is not limited to, numerical values, numerical ranges, photomicrographs, pictures of biological or medical specimens, autoradiographs, annotations, and logical values. The source data is machine-readable and machine-searchable and is therefore available for re-use and re-analysis. In this context the term “making available” is intended to imply making possible the representing, storing, distributing and/or searching of data.

The system also comprises computer-readable metadata that describes the content of datasets including the source data.

The disclosure also teaches an interface that enables connections to be made between scientific literature and biomedical databases and other data repositories. The biomedical databases and other data repositories may be curated or un-curated.

The method and system of this disclosure enable new data-oriented search strategies to be performed and furthermore allows integration of the research data across the literature and between biomedical databases and other data repositories. The method and system will, in addition to making the research data easier to re-use, add increased transparency to the reporting of scientific research.

The disclosure teaches a system for associating data with figures. The system comprises a figure storage database for storage of a plurality of figures or of links in the Internet or an intranet to figures as well as one or more data files (or uniform resource indicator thereof) storing a plurality of data items associated with the plurality of figures or panels of the figures. The links in the Internet can be a uniform resource indicator (URI), such as a uniform resource name or uniform resource link, The system further comprises a curation tool that is adapted to access the figure storage database and the data files in order to create the links between elements of the figures and at least one set of the plurality of data items. The term “elements” in this context includes the complete figures, panels in the figures, short textual labels on the figure and longer textual explanatory legends associated to the figures, annotations and/or other components of the figures.

This enables the user of the system to create links between elements of the figures the corresponding research data used to generate the figures.

In one aspect of the system, connections for accessing remote databases are also supplied. This enables the user to correlate the research data with additional, supplementary or complementary information in the remote databases. The system comprises in a further aspect one or more legends which can be used as “indices” for the databases.

The disclosure also teaches a method for creation of a figure representation database, which comprises the following steps: identifying one or more legends associated with the figure and accessing a plurality of data items associated with the figures. The plurality of data items can then be associated with the one or more legends and links created between at least one of the figures and least one of the plurality of data items.

The method further includes access to a nomenclature database (which can be stored locally or remotely) and comparing elements of the one more legends with entries in the nomenclature database in order to establish standard terminology. For example, elements from one or more of the legends could be replaced with alternative entries supplied from the nomenclature database.

In a further aspect of the invention terms can be extracted from textual elements on the figures and used for textual analysis, such as data mining. Search engines can then read these terms.

### DETAILED DESCRIPTION OF THE FIGURES

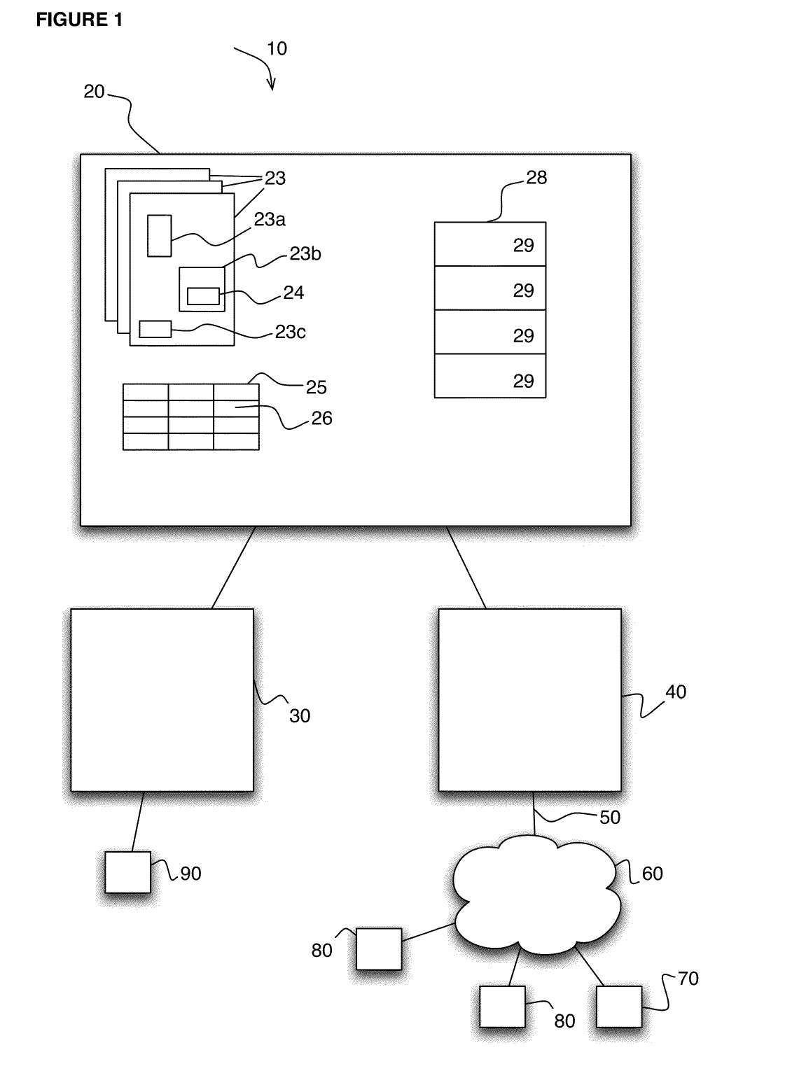

FIG. 1 shows an examplary embodiment of the system.

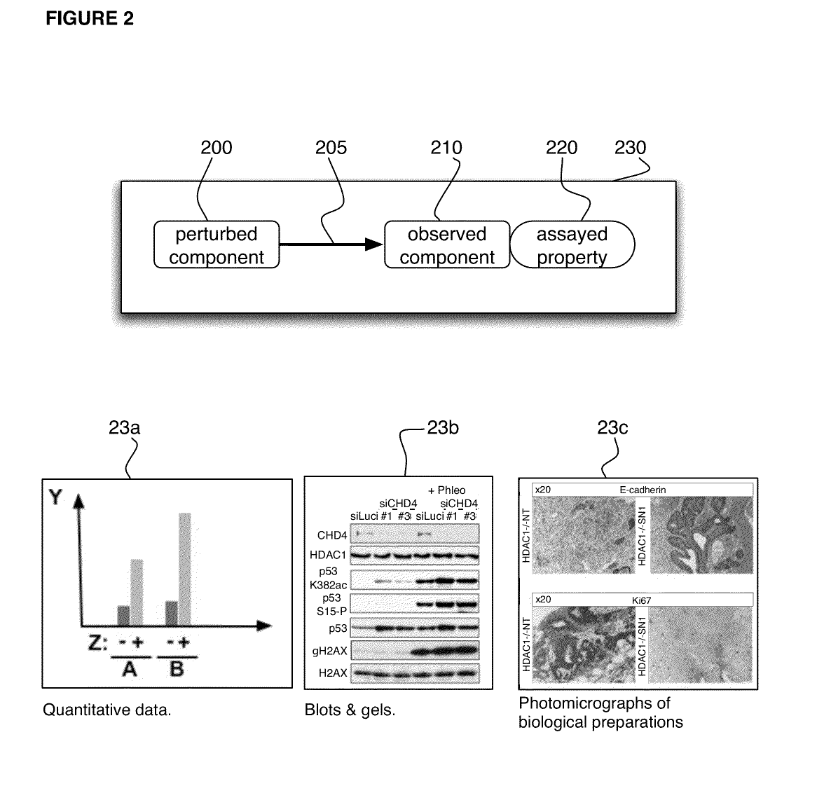

FIG. 2 shows a a perturbation—observation.

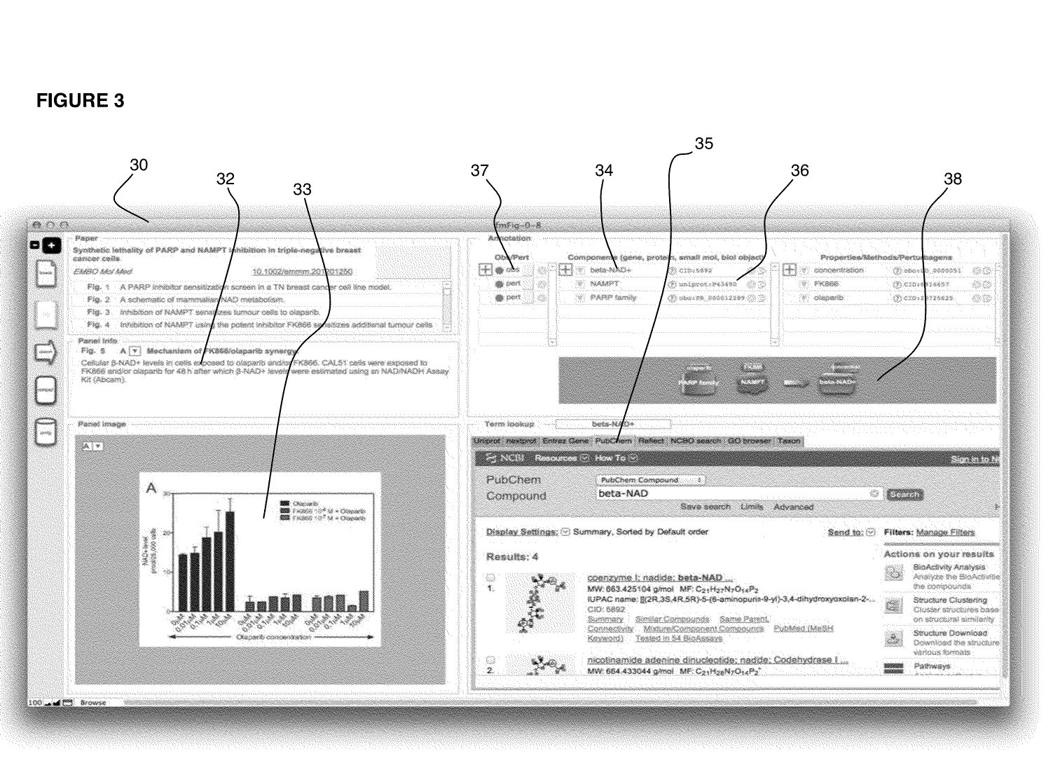

FIG. 3 shows an interface for a curation tool.

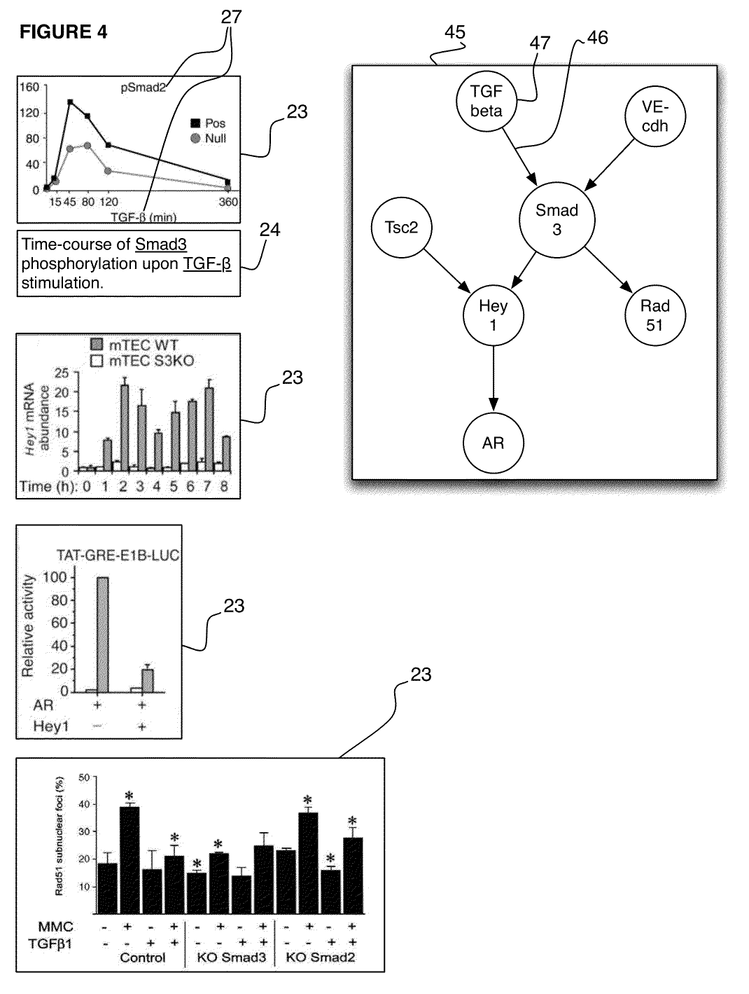

FIG. 4 shows a map created from annotated figures.

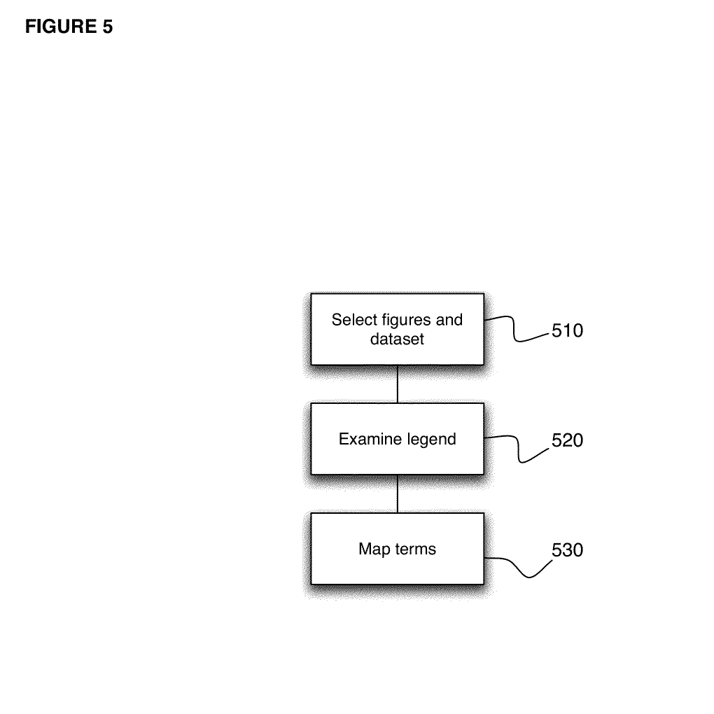

FIG. 5 shows a flow chart of the method.

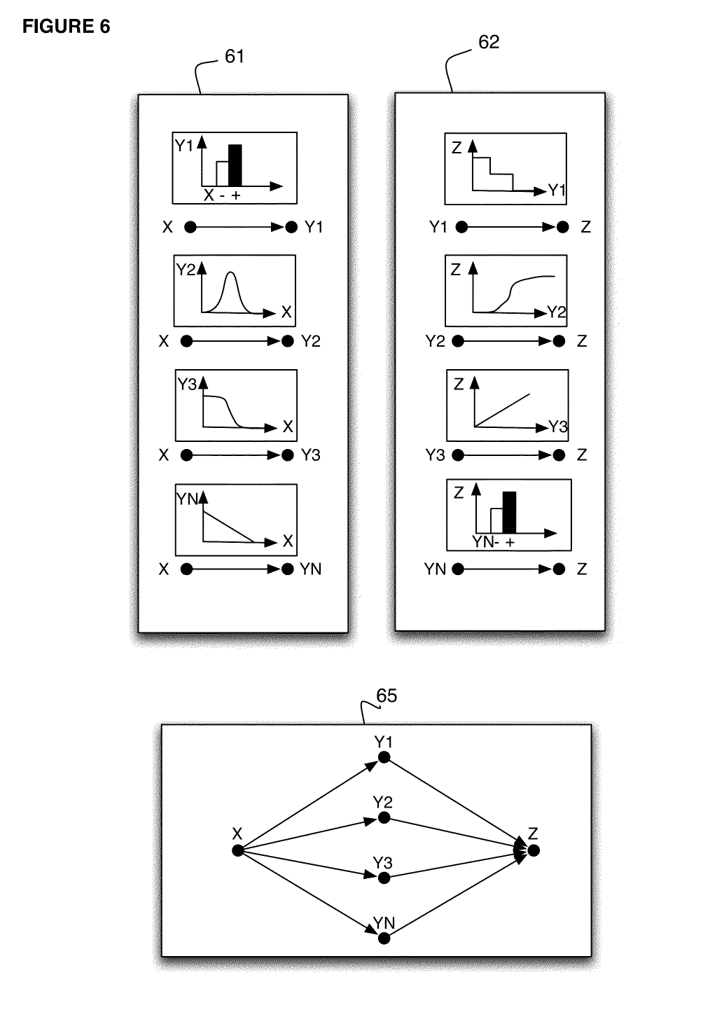

FIG. 6 shows an example of the figures and graphs.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

The method and system of this disclosure enables an association or a linking of published figures from a scientific paper with underlying research data or ‘source data’ and with curated machine-readable metadata. This method and system:
Promotes rigorous, transparent scientific reporting practices,
Encourages an emergence of standardized ways to present research findings in the scientific papers

Reduces the incidence of inappropriate data processing and fraud.
Facilitates re-use and re-analysis of the underlying research data.
Enables novel search strategies of the underlying research data that overcome fundamental limitations of current keyword-based searches of scientific literature.
Allows data integration across the scientific literature as well as with data repositories.

FIG. 1 shows an exemplary embodiment of the system 10 of this disclosure. The system 10 comprises three main components:
A figure representation database 20 to link FIGS. 23 published in the scientific literature with data files 25 containing a plurality of data items 26 of the underlying research data in the data files 25 and a metadata store 28 containing a plurality of machine-readable metadata items 29 and so create a “structured representation” of the FIGS. 23. The FIGS. 23 have figure legends 24 and labels 27.
A curation tool 30 to help standardize the figure legends 24, annotate the data files 25 storing the research data and streamline acquisition of the machine-readable metadata items 29 and store the metadata items 29 in the metadata store 28. The curation tool 30 is connected to a nomenclature database 90, as will be described later with respect to FIG. 3.
A search platform 40, which will exploit the structured representation of the FIGS. 23 in the figure representation database 20 to perform semantic searches of the scientific literature.

It will be appreciated that the system 10 shown in FIG. 1 is a simplified representation. There can be more than one figure representation database 20 which will store structured representations of more than one scientific paper. Connections 50 to the search platform 40 indicate access to one or more data repositories through the Internet 60 (or an intranet) as well as to other databases 20′ on other systems and/or other search engines 70, such as but not limited to the Google search engine.

The figure representation database 20 is stored in one or more storage areas. The storage areas include, but are not limited to, solid-state memory, disc drives, tapes, cloud-based storage. Storage of and access to the figure representation database 20 is carried out using database management programs.

The FIGS. 23 have a number of elements. For example, the FIGS. 23 are often composed of multiple ones of individual panels 23a-c. Each one of the individual panels 23a-c could represent a different type of experiment or variations on an experiment. Therefore the FIGS. 23, the underlying research data 25 and the metadata items 29 will be linked at the level of individual panels 23a-c. Other elements of the FIGS. 23 include textual elements, such as the labels 27 and the legends 24, associated with the FIGS. 23 or the panels 23a-c or data curves.

The data files 25 containing the research data will generally not be structured. An unstructured data file 25 containing the underlying research data associated with an individual one of the panels 23a-c in the published FIG. 23 represents one aspect towards a better access to the underlying research data. In a further aspect of this disclosure, the metadata items 29 associated with the individual panel 23a-c are defined to enable access to the data items 26 of the research data in the data file 25 in a more structured manner.

The metadata store 28 contains the machine-readable metadata items 29 that describe content and context of the research data in the associated data files 25. This can be best understood by considering that the published scientific papers contain “human-readable descriptions” of the research data. The metadata store 28 can be used for efficient search of the research data and integration of the research data from the published scientific paper with data stored in other data repositories 80 accessed through, for example, the Internet 60. These metadata items 29 in the metadata store 28 add a factual or objective description of the research data that complements the author's own interpretation of the research data in the text of the published scientific paper.

The system 10 defines the content of metadata items 29 so that metadata items 29 encode essential scientific information about the experiments reported in the published scientific paper. To accommodate a broad variety of research data and experimental designs, the metadata items 29 have a fundamental structure common to most empirical data in the science. It is possible that the fundamental structure may differ from one area of scientific knowledge, e.g. life sciences, to another area of scientific knowledge, e.g. astronomy. Alternatively and additionally there may be a “superstructure” for the metadata items 29 used in all areas of scientific knowledge and “substructures” for different branches of scientific knowledge.

The concept of the structure and content of metadata items 29 can be illustrated by considering an experiment reported in a scientific paper in the life sciences. The following information will be recorded in the experiment and illustrated on the FIG. 23 as shown in FIG. 2:
The biological components 200 that are the target of a perturbation 205 (for example, a drug treatment or a genetic modification).
The observed biological components 210 that are the object of the observations or measurements of the resulting response (for example, the expression of a gene or a phenotype).
The type of experimental assay 220 used to perform the reported experiment.
The set of biological components that form the experimental system 230 under investigation.

The results of the ‘perturbation-observation-assay’ representation of this experiment are shown in FIG. 2 and will be applicable to a broad range of reported experiments across many different data types while describing causal empirical relationships that are of central importance in experimental biology. The legends 24 are “Quantitative Data” in panel 23a with A and B labels 27 and “blots” and “gels” in panel 23b,

The metadata items 29 will comprise two levels of annotation in this aspect. The levels of annotation describe experimental biological variables at different levels of detail and enable the provision of a flexible and scalable structure for the metadata items 29:
Level 1: manual ‘tagging’ of terms in the figure legends 24. Examples of such figure legends include, but are not limited to perturbation, observation, and assay. The associated data items 26 of the research data stored in the data files 25 will enable users to extract the relationships between the experimental perturbations and the observations that describe the biological content of the research data.
Level 2: the tagged terms will be converted into machine-readable identifiers using database identifiers and controlled vocabularies from existing or created ontologies.

The curation tool 30, shown as an example in FIG. 3 on a typical display device, such as a monitor, is used to assist users, such as data curators and authors, to annotate the FIGS. 23, the figure legends 24, the illustration labels and the column headers in the related data files 25 with machine-readable metadata items 29. Technologies such as Reflect (reflect.ws) or the NCBO Annotator (bioportal.bioontology.org/annotator), will be incorporated in an interface to make automated suggestions from nomenclature databases 90 that can be manually confirmed and help the users to browse the ontologies to find appropriate standard identifiers and links to biological databases. The legends 32 from the figure are parsed to extract terms 34 that specify the components involved in the experimental system 230 used to generate the data displayed in associated figure panel 33. Comparison of the terms 34 with entries in nomenclature databases 90, as shown in nomenclature display 35, allows encoding using standard identifiers 36. FIG. 3 shows in one area of the display the terms 34 in one column and the standard identifiers 36 in a second column. Classification of the role 37 of the biological components as perturbation or observation allows generation of the structured metadata items 29 that represents the experiment shown in the figure panel 33. The resulting structured metadata items 29 are stored and can be rendered in a graphical way to generate a simplified illustration 38 of the experimental system 30.

The curation tool 30 provides an intuitive interface for display on the display device that allows manual or semi-automated extraction of the information included in the figure legends 24, 32 and the construction of an abstracted structured representation in a stepwise manner.

The curation tool 30 also provides means to identify gaps and missing information in the figure legend 24, 32 and allow enables this missing information to be added back into the text of the figure legend 24, 32, so that the missing information can be used both for curation and authoring tasks.

The curation tool 30 enables automated or semi-automated mapping by the user of the structured descriptions onto the unprocessed data files 25 that underlie the FIG. 23 to specify the nature of the data items 26 in the data files 25 (for example, to add an standardised description to one or more of the columns in a data table stored in the data files 25).

The resulting structured annotation will be stored as the metadata items 29 in the metadata store 28 of the figure representation database 20. In one aspect, the metadata items 29 will be represented as collections of ‘subject-predicate-object triples’ using semantic web technologies, such as RDF/OWL, and semantic ‘triplestores’. For example, the relationships “gene_X tested_for_its_effect_on protein_Y”, the subject is ‘gene_X’, the predicate is ‘tested_for_its_effect_on’ and the object is ‘protein_Y’. The annotations may also be included directly into documents published online, for example by marking up HTML documents using RDFa/microdata/microformats or related technologies. This will enable publishers of the scientific literature to remain independent of a central information source and other search engines while benefitting from the semantic information included in the scientific paper. Microdata is supported by Google, for example.

Readers of the scientific papers will be able to download the annotated ‘source data’ files 25 directly from the FIG. 23 by, for example, selecting one or more of the individual panels 23a-c on the FIG. 23 using conventional techniques. The research data relating to the FIG. 23 (and, if appropriate, any further related data items 26 and/or the metadata item 29) will thus be available for re-analysis. One example of re-analysis is to apply a different statistical treatment of quantitative research data. The system 10 will also enable a greater transparency on the research data used to generate the published figure (for example, number of replicates, variability of the research data). This will contribute to preventing data manipulation and misrepresentation.

The system 10 complements text search technology in a non-redundant manner by providing access to semantically structured information in the metadata store 28. Search engines have become common to retrieve information from the scientific literature. Current keyword-based searches are often restricted to the title and/or the abstract of the scientific paper and rely on the author's interpretation and textual descriptions of scientific findings. A survey recently conducted on European research group leaders and journal readers indicates that one of the major bottlenecks in the literature search is the lack of specificity of the results returned by the search engines, such as PubMed. Too many irrelevant papers are returned in response to the search query, making it difficult to find specific information. In particular, it is very challenging for text-based methods to retrieve information on specific relationships. For example, it is difficult to obtain answers to relational queries such as ‘what hormones raise blood glucose levels?’ or ‘what factors cause phosphorylation of transcription factor X?’. The annotations and the metadata items 29 are designed to encode such relationships and thus the search queries of this type will become tractable.

One additional search function that will be facilitated by the system and method is the ability to find the published research data and those experiments that are similar to a future experiment that is about to be planned in the lab or to a given figure published in a paper.

The metadata items 29 in the metadata store 28 will also make it possible to find pairs of matching perturbation-observation relationships. For instance, let us assume a Figure F1 illustrating an experiment E1 where the effect of the perturbation of component A (the genetic disruption of gene A, for example) is measured on the component B (the expression level of protein B, for example). Experiment E1 can thus be represented by the relationship R1 “A=>B”. Let us assume a second figure F2 showing an experiment E2 where the effect of perturbing component B′ is measured on C and can be represented by the relationship R2 “B′=>C”. If the components B and B′ are identical or sufficiently similar, the two relationships R1 and R2 can be ‘joined’ into a three component ‘pathway’ “A=>B=>C”. The relationships represented by metadata items 29 of the metadata store 28 can be used to organize the experiments shown in the plurality of FIGS. 23 and their associated data files 25 into a network of semantically linked datasets which can be navigated to discover related experiments and the respective papers as is shown in FIG. 4.

The resulting network is represented by a graph 45 of system 10, where the directed edges 46 are the directed relationships represented in each metadata items 29 of the metadata store 28 and nodes 47 represent biological components.

Programmatic access to the figure representation database 20 via an Application Programming Interface (API) facilitates the development of downstream applications and the integration into other resources, publishers' websites and major literature repositories.

The system 10 will also enable the integrating of the results of the reported experiments that assay the same biological components in different contexts. This will enable a generation of new hypotheses. For example, if in a first one of the scientific papers, one or more of the FIGS. 23 shows that inhibition of kinase X reduces phosphorylation of protein Y, in a second scientific paper these two proteins are shown to interact physically while a third scientific paper demonstrates that X regulates the transcriptional activity of Y, it suggests that X could regulate Y by direct phosphorylation. The annotation and encoding the biological content of the FIGS. 23 using standardized identifiers will greatly facilitate such integration of related findings. The graphs 45 similar to that shown in FIG. 4 can be generated using the method of this disclosure to provide inputs to a graphical display tool.

Based on the topology of the graph 45, metrics will be defined to rank the results returned by the search platform 40 when querying the database 20. Components and relationships of the graph can be ranked using topological properties of the corresponding nodes 47 and the edges 46 within the network 45. In one example, measures of node centrality that are known in mathematical graph theory, including but not limited to node ‘in-degree’ or ‘out-degree’, ‘closeness centrality’, ‘betweenness centrality’, ‘Eigenvector centrality’, ‘PageRank’ will be used to rank the biological components represented by the nodes 47 and prioritize search results that include components that occupy a highly connected or central position in the graph 45. For example, let us assume that a search query returns several figure panels 33 showing experiments involving components X, Y or Z. Furthermore, let us assume that the positions of these components in the graph 45 is such that the node X has ten edges pointing outwards (out-degree=10), node Y has fifteen outwards edges (out-degree=15) and node Z has a single outward edge (out-degree=1). In this simplified example, the search results including component Y would be prioritized based on the higher out-degree of Y, which indicates that this component has been a more frequent target of experimental perturbations reported in the literature as compared to the components X, or Z, and might thus be of more relevance.

In another example, the local patterns of connections represented by the directed edges 46 of the nodes 47 representing the components will be used to compute metrics that rank the components according to their biological role and importance. One aspect will be dedicated to prioritize important biological regulators (and is shown in FIG. 6). In this aspect, two sets of experiments are ‘joined’. The first set 61 includes experiments in which the effect of perturbing one specific molecular component X is tested on a several components {Y1, Y2, Y3, . . . , YN}. The second set (62) of experiments investigates the role of the same set of components {Y1, Y2, Y3, . . . , YN} on a component Z. The metadata store 28 include the metadata items 29 that enable the systematic identification within the graph 45 of such sub-sets of connected nodes 47 (a ‘sub-graph’) and the computing of metrics that characterize their structure. For example, the ‘master-regulator motif 65 is characterized by a sub-graph composed of the nodes {X, Y1, Y2, . . . YN, Z} that are connected according to a divergent pattern “X=>{Y1, Y2, Y3, . . . , YN}” followed by a convergent pattern {Y1, Y2, Y3, . . . , YN}=>Z″. An example of metric that characterizes the structure of the master-regulator motifs 65 is the degree of divergence/convergence N that indicates the importance of a component X as regulator ('master regulator’) of Z.

Many controlled vocabularies have been created in the form of ontologies (see for example BioPortal http://bioportal.bioontology.org). The system 10 can access the existing ontologies, for example the Gene Ontology (GO), Ontology of Biomedical Investigations (OBI), BioAssay Ontology (BAO), Evidence Code Ontology (ECO) through the Internet 60 and shown in FIG. 1 as the nomenclature database 90.

FIG. 5 shows an example of an author using the curation tool 30 to link the FIGS. 23 (or one or more of the individual panels 23a-23c) with the data files 25. In a first step the author will need to select one (or potentially more than one) FIG. 23 or individual panel 23a-c and one or more data sets from which the FIG. 23 or panel 23a-c was generated. The data sets can be in a structured form such as a data table or comma separated values.

In the next step 520, the legends 24 on the FIG. 23 (or panel 23a-c) will be examined The legends 24 can be either imported automatically from the FIG. 23, which is aided if the legends 24 are generated using, for example, an XML descriptor. Alternately the legends 24 may be manually using the curation tool 30.

In one aspect of the inventions, the terms used in the legend 24 is compared with an ontology database and/or a style database collectively termed the nomenclature database 90. The ontology database is used to identify any possible synonyms (preferred or otherwise) for the terms in the legend. The style database can be a database used for a particular publisher or for a particular branch of scientific knowledge and enables the same style to be used in terms.

The terms are mapped in the next step to the data files 25. For example all of the data items 26 in one column of a data table might be related to one axis of the FIG. 23. The legend 24 associated with this one axis would be linked to this column and recorded as the metadata items 29. In other words, any user of the figure representation database 20 in future could chose the axis, for example by clicking on the axis or the associated legend with a mouse, and be directed to the associated data items in the data files 25.

This process is repeated for all of the FIGS. 23 or panels 23a-c. It is possible that the data files 25 may contain data items 26 that are not to be found in the FIGS. 23 or planes 23a-c. The author of the scientific paper can still annotate these data items in a further step.

In a further aspect of the invention, the terms of the figure legends 24 are compared to the labels 27 appearing on the FIG. 23. The text of the labels 27, their position and orientation are extracted from the image either by optical character recognition (OCR) or by mining of the original image files. A comparison between the text of the labels 27 and the terms from the associated figure legend 24 allow the location of matching words. The matched words tend to have a high degree of relevance for the interpretation of the FIG. 23. It will be noted that the term “matching” does not imply that the words are identical; the matched words could be synonyms or be different inflexions of the same word.

The position and orientation of the labels 27 on the FIG. 23 tend to occupy stereotypical positions on quantitative graphs and charts forming the FIGS. 23. For example, Y-axis labels tend to be on the left of the FIG. 23 and to be written in a vertical orientation; X-axis labels tend to be in the lower part of the FIG. 23. Statistically, the position and orientation of all of the text elements in graphs or charts—not just the Y-axis labels and the X-axis labels—provide information on the meaning of the text elements. This information is complementary to the information extracted by text mining techniques applied to the figure legends 24.

Joint analysis methods allow the combining of both sources of information from text analysis and visual analysis in order to improve the performance of text-mining methods. One application of interest is the inference of the directionality of relationships represented in graphs or charts shown in FIGS. 2 and 6 displaying quantitative perturbation-measurement experiments using the positional information from the figure labels 27 and the textual analysis from the figure legends 27.

In one example, sixty-four figure panels representing quantitative data related to the TGFβ signalling pathway and their associated figure legends 24 were used. The text labels 27 were extracted by Optical Character Recognition, automatically compared to the figure legend 24 to find relevant matching words and the associated one of the X-axis or the Y-axis according to their position and orientation using simple thresholds. This approach demonstrated that 70% of the 230 terms extracted from the figure labels 27 were automatically assigned to the correct one of the X-axis or the Y-axis.

### REFERENCE NUMERALS

| | |
|---|---|
| 10 | System |
| 20 | Figure representation database |
| 20′ | Other database |
| 23 | Figures |
| 23a, 23b, 23c | Panels |
| 24 | Figure legends |
| 25 | Data Files |
| 26 | Data Items |
| 27 | Labels |
| 28 | Metadata data store |
| 29 | Metadata items |
| 30 | Curation Tool |
| 32 | Legend |
| 33 | Figure panel |
| 34 | Terms |
| 35 | Nomenclature display |
| 36 | Standard identifiers |
| 37 | Role |
| 38 | Simplified illustration |
| 40 | Search Platform |
| 45 | Graph |
| 46 | Directed edges |
| 47 | Nodes |
| 50 | Connections |
| 60 | Internet |
| 61 | First set |
| 62 | Second set |
| 65 | Mater-regulator motifs |
| 70 | Search engine |
| 80 | Data repositories |
| 90 | Nomenclature database |
| 200 | Biological components |
| 205 | Perturbation |
| 210 | Observed components |
| 220 | Experimental assay |
| 230 | Experimental system |

1. A system for associating data with figures comprising
a figure storage database for storage of a plurality of figures;
one or more data files storing a plurality of data items associated with one of more of the plurality of figures or panels; and
a curation tool adapted to access the figure storage database and the one or more data files in order to create links between elements of the plurality of figures and at least one set of the plurality of data items.

2. The system of claim 1, further comprising at least one or more connections for accessing remote databases.

3. The system of claim 1, wherein the figures include one or more legends.

4. The system of claim 3, wherein the curation tool is adapted to access the one or more legends and compare at least part of the accessed legend with entries in a nomenclature database.

5. The system of claim 3, wherein the curation tool is adapted to access the one or more legends and to generate metadata items from the accessed one or more legends.

6. The system of claim 1, wherein the curation tool is adapted to generate machine-readable metadata items representing directional relationships between perturbed components and assayed components depicted in at least one of the figures.

7. The system of claim 1, further comprising a query system for accessing and returning as output a subset of the plurality of figures.

8. A method for creation of a figure representation database comprising
identifying one or more legends associated with a figure;
accessing a plurality of data items associated with the figure;
associating the plurality of data items with at least one of the one or more legends;
creating links between the at least one figure and at least one of the plurality of data items.

9. The method of claim 8, further comprising accessing a nomenclature database and comparing elements of the one or more legends with entries in the nomenclature database to identify alternative entries.

10. The method of claim 9, further comprising replacing elements from the one or more legends with the alternative entries from the nomenclature database.

11. The method of claim 8, further comprising extraction of terms from textual elements on the figures.

12. The method of claim 11, further comprising determination of directional relationships of the textual elements.

13. The method of claim 11, further comprising using the extracted terms for text mining.

14. The method of claim 8, further comprising generating one or more metadata items from at least one or more of the legends.

15. A method of deriving a graph from a figure representation database comprising accessing one or more metadata items in the figure representation database;
associating one or more nodes of the graph metadata items representing components;
associating one or more directed edges of the graph with the metadata items representing connections between the components; and
displaying the graph on a display device.

16. The method of claim 15, further comprising ranking of the components according to their importance based on measures of the components in the graph, the measures being selected from at least one of centrality of the components and local patterns of connections.

17. The method of claim 15 wherein the components biological components and the ranking is based on properties of associated ‘master regulator’ motifs in the graph.
